(19) United States
(12) Patent Application Publication
(10) Pub. No.: US 2026/0098447 A1
(43) Pub. Date: Apr. 9, 2026

(54) SINGLE WHEEL LOWER ROLLER GUIDE ASSEMBLY FOR CANTILEVER GATES

(71) Applicant: FENCING SUPPLY GROUP ACQUISITION, LLC, Atlanta, GA (US)

(72) Inventor: Jeffrey A. Ketterer, Pearland, TX (US)

(21) Appl. No.: 19/299,665

(22) Filed: Aug. 14, 2025

Related U.S. Application Data
(60) Provisional application No. 63/703,313, filed on Oct. 4, 2024.

(51) Int. Cl. E06B 11/02; E06B 11/04

(52) U.S. Cl. CPC E06B 11/026; E06B 11/045

(57) ABSTRACT

A roller guide assembly for cantilever gates which improves existing designs by incorporating a single wheel lower roller guide. The single wheel roller guide assembly includes an elongated assembly body having an adjustment system that includes a guide wheel, a wheel axle member, an adjustment screw assembly and having a U-bolt at one end to facilitate attachment to a gate post. The guide wheel can be positioned in a longitudinal channel in the bottom of a cantilever gate and the adjustment system allows the guide wheel to be adjusted transversely in either direction relative to the cantilever gate through actuation of the adjustment screw assembly and fixed in place with the locking mechanism. In this regard, the adjustment system allows an installer to precisely set the cantilever gate's perpendicularity using a level, ensuring that the gate remains vertical during use.

### CROSS REFERENCE TO RELATED APPLICATIONS

This application claims the benefit of and incorporates by reference co-pending U.S. provisional patent application Ser. No. 63/703,313, filed Oct. 4, 2024.

### BACKGROUND OF THE INVENTION

### Field of the Invention

The present disclosure relates to an improved bottom guide design for cantilever gates, specifically featuring an adjustable single-wheel lower roller guide assembly.

### Description of the Prior Art

The use of gates as movable barriers placed at an opening of an enclosure or dividing structure (such as a wall) to provide a point of entry and exit for such an enclosure or dividing structure is well established. As the ability to move is generally fundamental to gates, gates may often be defined by their manner of movement relative to the opening they are associated with. For example, common types of gates include swing gates, sliding gates, and cantilever gates, with each of these not just having its own movement approach but also having its own advantages and limitations. For example, with cantilever gates, while they move horizontally like sliding gates, they do not require a ground track like sliding gates do. Instead, cantilever gates remain suspended above the ground while moving and typically move on roller guides that are integrated with the structure to which the gate is attached. Consequently, cantilever gates are often very useful in situations wherein linear movement is desired but where there may be uneven ground surfaces or ground surfaces which may be prone to accumulating debris or other material that could affect a ground track.

Notwithstanding such advantages, existing designs of roller guides for cantilever gates have been shown to present several problems. At present, cantilever gates commonly employ lower roller guides embodied two rollers that pinch the outside of a bottom gate frame member so as to keep the gate vertical and upright both while moving and while being held in place. Such a design, however, has posed issues such as safety concerns due to pinch points, potential wear or damage to the gate's surface finish, and difficulty in adjusting the rollers from both sides of the gate or fence line.

Accordingly, there remains a need for a lower guide design for cantilever gates which addresses the issues that remain with conventional lower roller guides by employing a single wheel lower roller guide. It is contemplated that such a single wheel lower roller guide approach for cantilever gates can offer improved safety, ease of installation, and maintenance.

### SUMMARY OF THE INVENTION

The present disclosure provides for a single wheel lower guide assembly for a cantilever gate, comprising: an assembly body having a first, attachment end, a second, adjustment end that is opposite the first end, and a top side; an attachment member which may be defined by a U-bolt that is configured to selectively couple with the first end of the assembly body, and when coupled with the first end, cooperatively grasp a gatepost positioned between at least a portion of the attachment member and at least a portion of the first end so as to secure the assembly body to the gatepost; an adjustment system which includes a single guide wheel, an axle, and an adjustment actuator, which may be defined as a screw assembly, with the guide wheel, axle, and adjustment actuator being interconnected with the guide wheel rotatable about the axle, wherein the adjustment system is integral with the assembly body with the guide wheel positioned above the top side; and wherein the adjustment system is configured such that selectively actuating the adjustment actuator causes the guide wheel to move in a first direction towards the first end or in a second direction towards the second end.

Embodiments of the single wheel lower guide assembly for a cantilever gate may also include a cover for the adjustment actuator.

It is an object of the present disclosure to provide a single wheel lower roller guide for cantilever gates which addresses the issues with conventional lower roller guide designs and offers improved safety, ease of installation, and maintenance.

This and other objects will be apparent to one of skill in the art.

### BRIEF DESCRIPTION OF THE DRAWINGS

FIG. 1 is a side perspective view of a two roller lower guide assembly built in accordance with the prior art.

FIG. 2 is a partial side perspective view of a cantilever gate with a two roller lower guide assembly built in accordance with the prior art.

FIG. 3 is a perspective view of a single wheel lower guide assembly for cantilever gates built in accordance with the present disclosure.

FIG. 4 is a top plan view of a single wheel lower guide assembly for cantilever gates built in accordance with the present disclosure.

FIG. 5 is an elevational view of the adjustment end of a single wheel lower guide assembly for cantilever gates built in accordance with the present disclosure.

FIG. 6 is a side elevational view of a single wheel lower guide assembly for cantilever gates built in accordance with the present disclosure, shown with the cover component removed.

FIG. 7 is a side elevational view of a cantilever gate with a single wheel lower guide assembly for cantilever gates built in accordance with the present disclosure.

FIG. 8 is a partial side elevational view of a cantilever gate with a single wheel lower guide assembly for cantilever gates built in accordance with the present disclosure.

FIG. 9 is a perspective view of an elongated body of a single wheel lower guide assembly for cantilever gates built in accordance with the present disclosure.

FIG. 10 is a perspective view of a guide wheel of a single wheel lower guide assembly for cantilever gates built in accordance with the present disclosure.

FIG. 11 is a perspective view of a wheel axle member of a single wheel lower guide assembly for cantilever gates built in accordance with the present disclosure.

FIG. 12 is a perspective view of an adjustment screw of a single wheel lower guide assembly for cantilever gates built in accordance with the present disclosure.

FIG. 13 is an exploded elevational view of an adjustment screw assembly of a single wheel lower guide assembly for cantilever gates built in accordance with the present disclosure.

FIG. 14 is a perspective view of a cover component of a single wheel lower guide assembly for cantilever gates built in accordance with the present disclosure.

FIG. 15 is a perspective view of a single wheel lower guide assembly for cantilever gates built in accordance with an alternate large size embodiment of the present disclosure.

FIG. 16 is a top plan view of a single wheel lower guide assembly for cantilever gates built in accordance with an alternate large size embodiment of the present disclosure.

FIG. 17 is an elevational view of the adjustment end of a single wheel lower guide assembly for cantilever gates built in accordance with an alternate large size embodiment of the present disclosure.

FIG. 18 is a perspective view of a single wheel lower guide assembly for cantilever gates built in accordance with a no cover embodiment of the present disclosure.

### DETAILED DESCRIPTION OF THE INVENTION

Described herein is a roller guide assembly for cantilever gates which improves existing designs by incorporating a single wheel lower roller guide. The single wheel roller guide assembly includes a single roller wheel that can be positioned in a longitudinal channel in the bottom of a cantilever gate and is integral with an adjustment system that allows the roller wheel to be adjusted transversely in either direction relative to the cantilever gate using a single adjustment screw assembly. This adjustment system allows an installer to precisely set the gate's perpendicularity and lock it in place using a level to ensure that the gate remains vertical during use.

Unlike the conventional designs which have a gate positioned between two rollers, which require adjustments from both sides of the gate because each roller must be adjusted, the design disclosed herein allows an installer to adjust and lock the single wheel in place from one side of the gate without the need to even reach underneath the bracket. As such, installation time can be greatly reduced and overall safety can be improved through the elimination of pinch points, which are potential hazards on sliding gates.

The single-wheel roller design also minimizes wear and damage to a gate, particularly a surface finish of a gate's bottom frame member such as powder coatings or paint. This type of damage is known to occur with the two-roller systems that pinch the gate. Furthermore, the simplified design eliminates the need for blind locking of the rollers from underneath the bracket, which is a common issue in conventional roller guides. By focusing on ease of use and safety, the roller guide assembly for cantilever gates disclosed herein presents a more efficient and reliable solution for maintaining gate alignment and functionality.

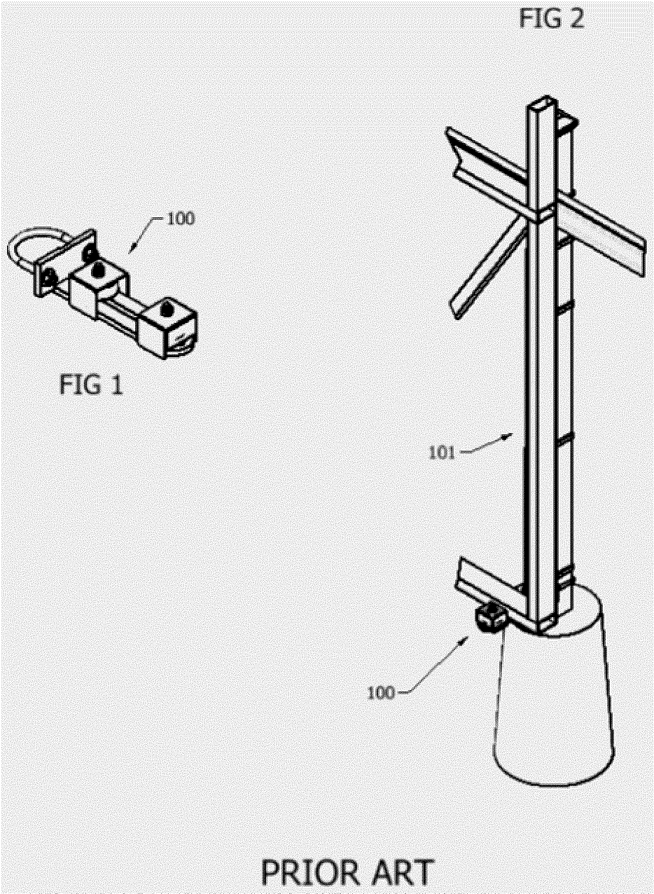

Referring now to the drawings and, in particular, FIGS. 1 and 2, a two roller lower guide assembly 100 is shown having a pair of adjustable roller wheels spaced apart longitudinally on an elongated assembly body. When in use on a cantilever gate 101, the gate 101 may be positioned so that it is above the guide assembly 100, with one of the roller wheels pressing into its front side and the other into its back side. In this regard, the roller wheels operate to assist with keeping the gate 101 upright in a vertical orientation. In addition, when the gate 101 is moved horizontally in an opening direction or a closing direction, the roller wheels can rotate in opposite directions while the gate moves in between them in order to minimize resistance while the roller wheels continue to press into the gate. In this regard, the two roller lower guide assembly 100 is able to assist with the gate's cantilever operation.

The single wheel lower guide assembly in accordance with the present disclosure offers a streamlined and efficient solution for maintaining gate alignment relative to the two roller lower guide assemblies seen in the prior art. The use of a single roller eliminates the pinch points associated with two-roller systems, while the adjustable design allows for fine-tuning of the gate's position. As such, the assembly disclosed herein not only enhances safety but also reduces the potential for surface damage to the gate's finish, making it a superior option for both residential and commercial cantilever gate systems.

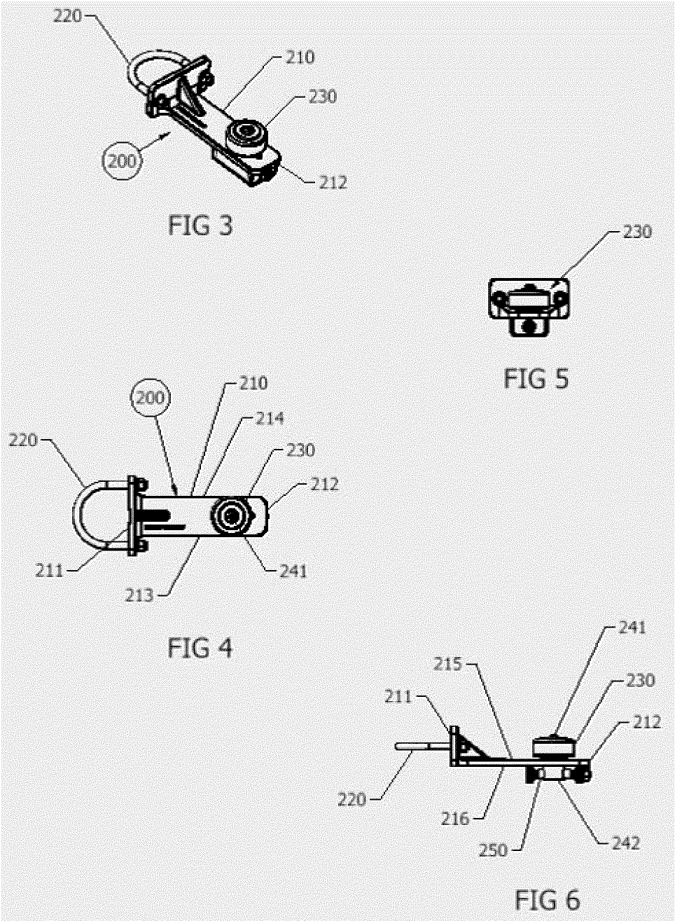

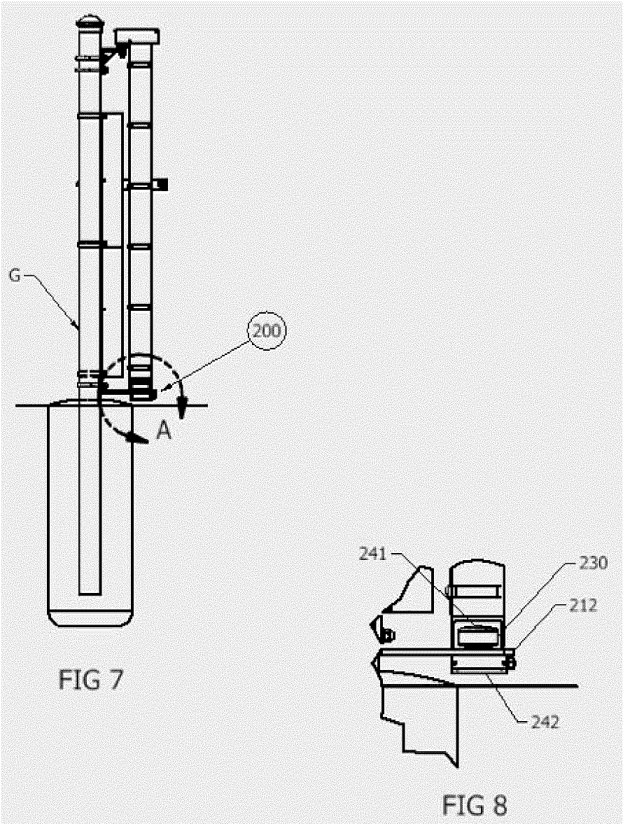

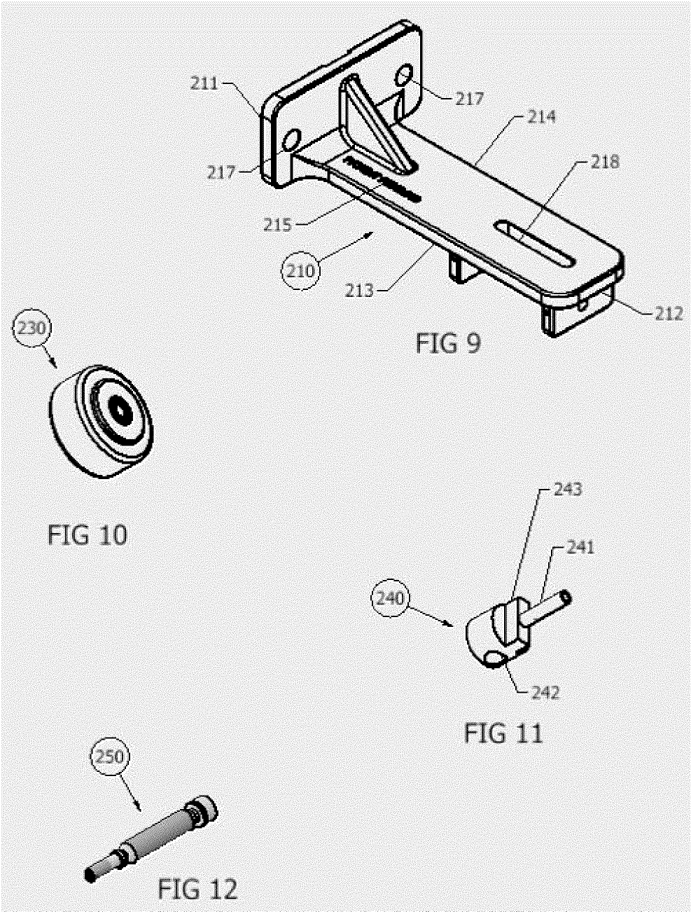

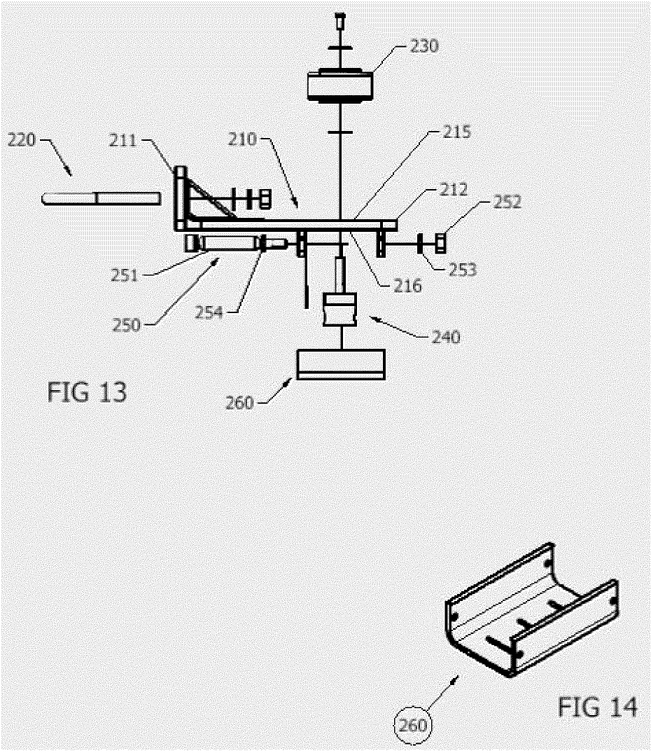

Referring now to FIGS. 3, 4, 5, 6, 7, 8, 9, 10, 11, 12, 13, and 14, a single wheel lower guide assembly 200 for cantilever gates is shown having an elongated assembly body 210, a U-bolt 220, a guide wheel 230, a wheel axle member 240, an adjustment screw assembly 250, and a cover component 260. The assembly body 210 includes an attachment end 211 and an opposing adjustment end 212, as well as a pair of mirror image longitudinal sides 213, 214, a top side 215 and a bottom side 216. The assembly body 210 may be defined as a casting or other rigid structure, and may be constructed of steel. The assembly body 210 serves as the main body of the single wheel lower guide assembly 200, housing the operative components and providing structural support for the entire assembly. In this regard, the assembly body 210 is constructed to be robust and durable, capable of withstanding the forces exerted during the gate's operation.

The U-bolt 220 is operative to ensure that the single wheel lower guide assembly 200 is securely fastened to a gatepost G or other fixed structure and can provide stable support for the overall mechanism. In this regard, the U-bolt 220 is configured to be selectively fastened to the assembly body 210 by engaging and being fastened into a pair of bolt holes 217 disposed at the attachment end 211 of the assembly body 210. Each end of the U-bolt may be threaded, so secure fastening may be attained by attaching a threaded nut on the end in the given bolt hole 217, as illustrated in FIGS. 3-6. This allows the single wheel lower guide assembly 200 to be selectively mounted to a gatepost G, with gatepost G positioned inside of the U-bolt 220 and the attachment end 211 of the assembly body 210. It is contemplated that the U-bolt 220 and the attachment end 211 may be constructed of various sizes in order to allow for the assembly body 210 to be attached to posts of various shapes and sizes, or to be attached to other fixed structures of various shapes, sizes and configuration. For example, while FIGS. 3-13 illustrate a U-bolt 220 and the attachment end 211 suitable for a 4-inch round post sizing and FIGS. 14-16 illustrate a U-bolt and the attachment end suitable for a 6-inch round post sizing, it is appreciated that the U-bolt and the attachment end may be sized and shaped to allow for a 4-inch square post, a 6-inch square post, or any other conventional size or shape post. It is contemplated, however, that alternate structures could be used with or in place of a U-bolt 220 in order to accomplish the securing of the assembly body 210 to another type of structure. For example, if it is desired to attach the assembly body 210 to a wall, anchor bolts (not shown) may be used with the assembly body 210 in place of the U-bolt 220.

At the core of the single wheel lower guide assembly 200 is an adjustment system, which is defined by the guide wheel 230, the wheel axle member 240, and the adjustment screw assembly 250. The adjustment system allows the position of the guide wheel 230 relative to the attachment end 211 and adjustment end 212 to be slidably changed and selectively fixed in place by way of the adjustment screw assembly 250. The wheel axle member 240, which includes both an axle portion 241 that is connected to the guide wheel 230 and a screw carrier 242 through which the adjustment screw assembly 250 passes, facilitates the transfer of rotary movement of the adjustment screw assembly 250 to linear movement of the guide wheel 230, thereby configuring the adjustment system such that selectively actuating the adjustment screw assembly 250 causes the guide wheel 230 to move linearly. The assembly body 210 includes an elongated adjustment slot 218, which the axle portion 241 passes through, to permit such linear movement. The wheel axle member 240 may also include an elongated boss 243 that slip fits into the elongated adjustment slot 218 of the assembly body 210 so as to prevent any part of the wheel axle member 240 from rotating when the wheel axle member 240 is coupled with the assembly body 210.

The wheel axle member 240 accomplishes the transfer of rotary movement of the adjustment screw assembly 250 to linear movement through the design of the screw carrier 242, which includes a threaded aperture sized to receive the adjustment screw assembly 250. As the adjustment screw assembly 250 includes a threaded exterior surface, the threaded aperture and the threaded exterior surface of the adjustment screw assembly 250 may be arranged such that rotating the adjustment screw assembly 250 in a first rotary direction causes the entire wheel axle member 240 to slide in a first linear direction and rotating the adjustment screw assembly 250 in a second rotary direction that is opposite the first linear direction causes the wheel axle member 240 to slide in a second linear direction that is opposite the first linear direction. Because the guide wheel 230 is connected to the axle portion 241, as the wheel axle member 240 slides, so does the guide wheel 230.

The T guide wheel 230, which may be defined as a 3-inch wheel, may be supported and secured by a hex socket button head cap screw and a flat washer. These components work in tandem to hold the guide wheel 230 in place while allowing it to rotate smoothly during gate operation. The axle portion 241, which is always oriented vertically, may run through the center of the guide wheel 230 and hold it firmly by way of a retaining ring. This arrangement enables the guide wheel 230 to roll inside a channel at the bottom of a gate, ensuring that the gate remains properly aligned and upright during movement.

Embodiments of the adjustment screw assembly 250 may include an elongated screw member 251 that is coupled with a jam nut 252, lock washer 253, and make-up spacer 254, with the jam nut 252, lock washer 253, and make-up spacer 254 integrated with the screw member 251 to operate as a locking mechanism which operates to secure the adjustment screw assembly 250 in place once the desired alignment is achieved. The locking mechanism also prevent the screw from loosening over time due to the gate's movement or external vibrations.

To facilitate precise adjustments, the single wheel lower guide assembly 200 may include a quarter-inch hex wrench (not shown), which can be used to tighten or loosen the adjustment screw assembly 250 as needed. Advantageously, an installer can make such adjustments easily from one side of the gate without having to reach underneath the bracket, simplifying the installation and/or maintenance process and improving safety.

The cover component 260 which may be defined as a shielding structure constructed of plastic or some other rigid material is included and positioned over the screw carrier 242 and portions the adjustment screw assembly 250. In this regard, the cover component 260 is configured as a safety device suitable to shield such components from environmental factors such as dirt and moisture, ensuring long-term reliability and reducing maintenance requirements. It is contemplated, however, that some embodiments may not include a cover component, as illustrated in FIG. 18.

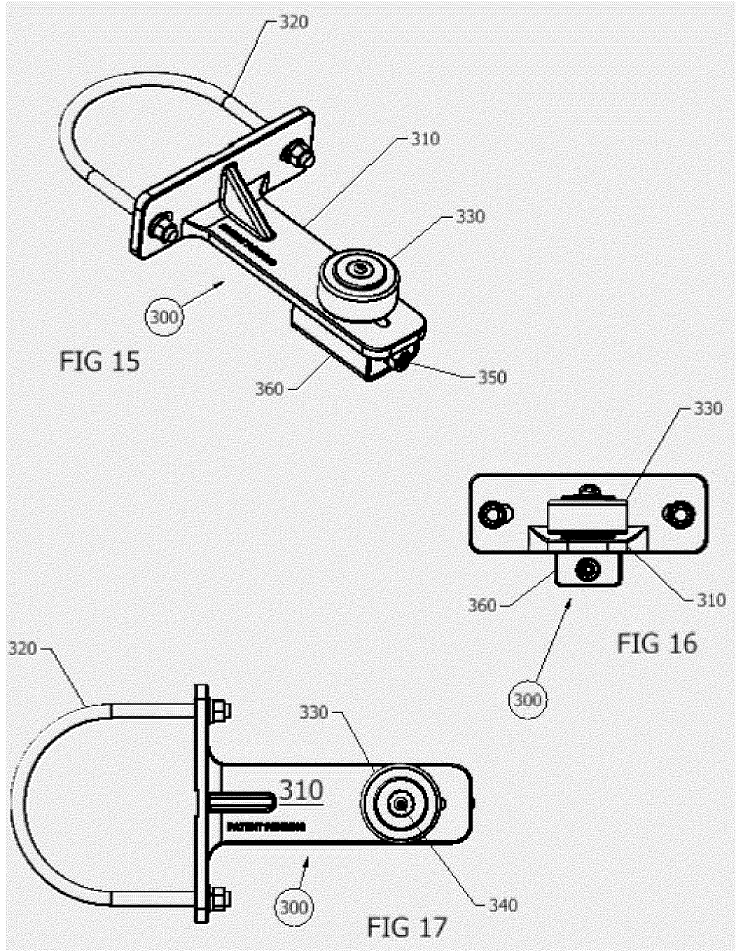

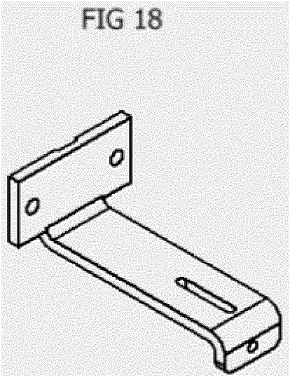

Referring now to FIGS. 15, 16, and 17, a large size embodiment of a single wheel lower guide assembly 300 for cantilever gates is shown having an elongated assembly body 310, a U-bolt 320, a guide wheel 330, a wheel axle member 340, an adjustment screw assembly 350, and a cover component 360. It is appreciated that the components of the large size embodiment may have the same properties and function as those in the embodiment shown in FIGS. 3-13, except that the attachment end of the assembly body 310 and the U-bolt 320 may be sized to fit around a larger post.

Referring now to FIG. 18, an embodiment of a single wheel lower guide assembly 400 for cantilever gates is shown without a cover component.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A single wheel lower guide assembly for a cantilever gate, comprising:
an assembly body having a first end, a second end opposite the first end, and a top side;
an attachment member configured to selectively couple with the first end of the assembly body, and when coupled with the first end, cooperatively grasp a discrete support structure positioned between at least a portion of the attachment member and at least a portion of the first end so as to secure the assembly body to the discrete support structure;
an adjustment system which includes a single guide wheel, an axle member, and an adjustment actuator, with the guide wheel, axle member, and adjustment actuator being interconnected with the guide wheel rotatable about the axle member, wherein the adjustment system is integral with the assembly body with the guide wheel positioned adjacent to the top side; and
wherein the adjustment system is configured such that selectively actuating the adjustment actuator causes the guide wheel to move in a first direction towards the first end or in a second direction towards the second end.

2. The single wheel lower guide assembly for a cantilever gate of claim 1, wherein the attachment member is defined by a U-bolt.

3. The single wheel lower guide assembly for a cantilever gate of claim 1, wherein the adjustment actuator is defined by a screw assembly having an elongated screw.

4. The single wheel lower guide assembly for a cantilever gate of claim 1, wherein the discrete support structure is defined by a gatepost and the attachment member, when coupled with the first end, cooperatively grasps the gatepost positioned between at least a portion of the attachment member and at least a portion of the first end by encircling the gatepost.

5. The single wheel lower guide assembly for a cantilever gate of claim 1, wherein at least a portion of the adjustment actuator is positioned adjacent to the second end.

6. The single wheel lower guide assembly for a cantilever gate of claim 1, wherein the assembly body includes a bottom side opposite the top side and the adjustment actuator is positioned adjacent to the bottom side.

7. The single wheel lower guide assembly for a cantilever gate of claim 6, additionally comprising a cover component integral with the assembly body and which together with a surface of the bottom side, encloses at least the adjustment actuator so as to shield the adjustment actuator for safety purposes and from environmental factors.

8. The single wheel lower guide assembly for a cantilever gate of claim 6, wherein the assembly body includes an adjustment slot sized and shaped to allow the axle member to be positioned to extend through the assembly body so that a portion of the axle member is adjacent to the top side and another portion of the axle member is adjacent to the bottom side and, while extending through the assembly body, selectively move in the first direction or the second direction.

9. A single wheel lower guide assembly for a cantilever gate, comprising:
an assembly body having a first end, a second end opposite the first end, a top side, and a bottom side;
an attachment member configured to selectively couple with the first end of the assembly body, and when coupled with the first end, cooperatively grasp a discrete support structure positioned between at least a portion of the attachment member and at least a portion of the first end so as to secure the assembly body to the discrete support structure;
an adjustment system which includes an interconnected guide wheel, axle member, and adjustment actuator, wherein the adjustment system is integral with the assembly body with the guide wheel positioned adjacent to the top side and rotatable about the axle member;
wherein the adjustment system is configured such that selectively actuating the adjustment actuator causes the guide wheel to move linearly in a first direction towards the first end or linearly in a second direction towards the second end;
wherein the adjustment actuator is positioned adjacent to the bottom side and at least a portion of the adjustment actuator is positioned adjacent to the second end, and includes a locking mechanism operative to hold the guide wheel in place when the adjustment actuator is not being actuated.

10. The single wheel lower guide assembly for a cantilever gate of claim 9, wherein the attachment member is defined by a U-bolt.

11. The single wheel lower guide assembly for a cantilever gate of claim 9, wherein the adjustment actuator is defined by a screw assembly having an elongated screw.

12. The single wheel lower guide assembly for a cantilever gate of claim 9, wherein the discrete support structure is defined by a gatepost and the attachment member, when coupled with the first end, cooperatively grasps the gatepost positioned between at least a portion of the attachment member and at least a portion of the first end by encircling the gatepost.

13. The single wheel lower guide assembly for a cantilever gate of claim 9, additionally comprising a cover component integral with the assembly body and which together with a surface of the bottom side, encloses at least the adjustment actuator so as to shield the adjustment actuator from environmental factors.

14. The single wheel lower guide assembly for a cantilever gate of claim 9, wherein:
the assembly body includes an adjustment slot sized and shaped to allow the axle member to be positioned to extend through the assembly body so that a portion of the axle member is adjacent to the top side and another portion of the axle member is adjacent to the bottom side and, while extending through the assembly body, selectively move in the first direction or the second direction; and
the axle member has an elongated boss that slip fits into the adjustment slot of the assembly body to prevent the axle member from rotating.

15. The single wheel lower guide assembly for a cantilever gate of claim 9, wherein the guide wheel is positioned above a surface of the top side.

16. The single wheel lower guide assembly for a cantilever gate of claim 9, wherein the adjustment actuator is positioned beneath a surface of the bottom side.

17. A single wheel lower guide assembly for a cantilever gate, comprising:
an assembly body having a first end, a second end opposite the first end, a top side, a bottom side, and an adjustment slot;
an attachment member configured to selectively couple with the first end of the assembly body, and when coupled with the first end, cooperatively grasp a discrete support structure positioned between at least a portion of the attachment member and at least a portion of the first end so as to secure the assembly body to the discrete support structure;
an adjustment system which includes an interconnected guide wheel, axle member, and adjustment actuator, wherein the adjustment system is integral with the assembly body with the guide wheel positioned adjacent to the top side and rotatable about the axle member;
wherein the adjustment system is configured such that selectively actuating the adjustment actuator causes the guide wheel to move linearly in a first direction towards the first end or linearly in a second direction towards the second end;
wherein the adjustment actuator is positioned adjacent to the bottom side, at least a portion of the adjustment actuator is positioned adjacent to the second end, and the adjustment actuator has a locking mechanism operative to hold the guide wheel in place when the adjustment actuator is not being actuated; and
wherein the adjustment slot is sized and shaped to allow the axle member to be positioned to extend through the assembly body so that a portion of the axle member is adjacent to the top side and another portion of the axle member is adjacent to the bottom side and, while extending through the assembly body, selectively move in the first direction or the second direction.

18. The single wheel lower guide assembly for a cantilever gate of claim 17, wherein the attachment member is defined by a U-bolt and the adjustment actuator is defined by a screw assembly having an elongated screw.

19. The single wheel lower guide assembly for a cantilever gate of claim 18, wherein the discrete support structure is defined by a gatepost and the attachment member, when coupled with the first end, cooperatively grasps the gatepost positioned between at least a portion of the attachment member and at least a portion of the first end by encircling the gatepost.

20. The single wheel lower guide assembly for a cantilever gate of claim 19, additionally comprising a cover component integral with the assembly body and which together with a surface of the bottom side, encloses at least the adjustment actuator so as to shield the adjustment actuator from environmental factors.
